(19) United States
(12) Patent Application Publication
(10) Pub. No.: US 2025/0173424 A1
(43) Pub. Date: May 29, 2025

(54) SYSTEM AND METHOD TO ENFORCE POLICY USING A USER-SPACE SANDBOX

(71) Applicant: Battelle Memorial Institute, Columbus, OH (US)

(72) Inventors: Peter J. Dohm, Lakewood, OH (US); Bohdan M. Paselsky, Westerville, OH (US)

(21) Appl. No.: 19/037,403

(22) Filed: Jan. 27, 2025

Related U.S. Application Data
(63) Continuation of application No. PCT/US2023/071030, filed on Jul. 26, 2023.
(60) Provisional application No. 63/369,555, filed on Jul. 27, 2022.

(51) Int. Cl. G06F 21/53

(52) U.S. Cl. CPC G06F 21/53; G06F 2221/033

(57) ABSTRACT

In an approach to enforcing policy without collateral damage using an agent sandbox, a system includes computer processors; non-transitory computer readable storage media; and program instructions to fork execution from a parent agent process into a child agent process; receive on the child agent process a target-specific object code of a capability; load on the child agent process a shared library using code inherited from a statically linked address space of the parent agent process; and interpose each standard C library wrapper function on the child agent process on a corresponding libc call. For each libc call, parse a message on the parent agent process to determine if the libc call is allowed by policy; responsive to determining that the libc call is allowed by policy, proceed with the execution; and responsive to determining that the libc call is not allowed by policy, terminate the child agent process.

### CROSS-REFERENCE TO RELATED APPLICATIONS

The present application is a ByPass Continuation of International Application No. PCT/US2023/071030 filed Jul. 26, 2023, which claims the benefit of the filing date of U.S. Provisional Application Ser. No. 63/369,555, filed Jul. 27, 2022, the entire teachings of which is hereby incorporated herein by reference.

### STATEMENT REGARDING FEDERALLY SPONSORED RESEARCH OR DEVELOPMENT

This invention was made with government support under Contract No. HR001118C0063 awarded by the Defense Advanced Research Projects Agency of the Department of Defense. The government has certain rights in the invention.

### TECHNICAL FIELD

The present application relates generally to cyber security and, more particularly, to a system and method for enforcing policy without collateral damage using an agent sandbox.

### BACKGROUND

In computer security, a sandbox is a mechanism for isolating running programs, usually in an effort to mitigate system failures and/or software vulnerabilities from spreading. It is often used during testing to execute untested or untrusted programs or code, possibly from unverified or untrusted sources, without risking harm to the host machine or operating system. A sandbox typically provides a tightly controlled set of resources for guest programs to run in, such as storage and memory scratch space. Network access, the ability to inspect the host system, or read from input devices are usually disallowed or heavily restricted.

Collateral damage is generally defined as damage inflicted that is an incidental result of an activity. In the field of cyber security, cyber collateral damage may be defined as unintended harm to a computer or information system that is not the target of a legitimate cyber security operation. In this case, the “harm” may be defined as the deletion, manipulation, or alteration of computer code governing the operation of hardware or software that is not specifically intended by the party conducting the legitimate cyber security operation, or the compromise of the integrity or availability of a computer network or data, or exfiltration of data, that is not specifically intended by the party conducting the legitimate cyber security operation.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a distributed data processing environment consistent with the present disclosure.

FIG. 2 is an example block diagram illustrating one possible design of an agent sandbox architecture consistent with the present disclosure.

FIG. 3 is a sequence diagram depicting operations for the sandbox program, for enforcing policy without collateral damage using an agent sandbox, on the distributed data processing environment of FIG. 1, consistent with the present disclosure.

FIG. 4 is an example of the shared-library linkage for an example capability consistent with the present disclosure.

FIG. 5 is an example dump of the sections from the Executable and Linkable Format (ELF) headers of a typical capability shared library consistent with the present disclosure.

FIG. 6 is an example of the unresolved symbols in a typical capability, consistent with the present disclosure.

FIG. 7 is an example of one of the agent wrapper functions that checks the invocation of the standard C library (libc) call write( ), consistent with the present disclosure.

FIGS. 8A, 8B, and 8C are an example of the entry-point function that every capability must implement to allow the agent to invoke it consistent with the present disclosure.

FIG. 9 depicts a block diagram of components of the computing device executing the sandbox program within the distributed data processing environment of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Many software systems that include formally verified logic must ultimately execute portably across a wide variety of imperfect operating systems. There is historically no universal way to build a policy enforcement engine that controls the execution of potentially undesirable actions to confirm that they abide by an operator-specified policy. For example, if a software agent should never be allowed to write to a disk, there exist importable ways to disallow the agent to do so, but there exists no portable method across every operating system to ensure that no writes can occur in the normal execution of the software. There are operating-system specific policy enforcement mechanisms (e.g., SELinux, grsecurity®, others) that attempt to solve this the “theoretically right” way, but there exist no universal solutions. Engineers are left to build platform-specific solutions which amplifies maintenance costs dramatically. There are some loose parallels in the sandboxes provided by web browsers like Chrome, but they are far more limiting than the approach disclosed herein.

In addition, existing policy enforcement mechanisms can result in collateral damage to the monitored system. These existing policy enforcement mechanisms may, for example, potentially crash the system, or require that the target system be rebooted to repair an exploit. This may be perfectly acceptable to use against a SOHO router because the impact is very low should it simply reboot, but its use is another consideration altogether on a life-critical medical device where the patient's life may be endangered upon rebooting.

What is required is a system that can be injected into a target, monitor processes on the target for undesirable actions, and block those undesirable actions without the possibility of collateral damage. Disclosed herein is a highly portable (across platforms) approach for a system and method to control the execution of potentially undesirable actions that a software agent must execute on a device by isolating it in a carefully crafted jail, i.e., sandbox, that uses no operating-system enforced mechanisms to implement these controls, yet the agent can fully control execution of all potentially undesirable actions per a policy. The disclosed system can be used to exploit, penetrate, and propagate throughout a target network and execute capabilities such as threat detection and neutralization without compromising the stability of the target systems.

The approach disclosed herein provides a very high degree of confidence that the software constrained with an a priori policy simply cannot violate these policies without being detected. This is specifically a solution to confirm that behavior tested in a test environment cannot change once it is operating in a real-world environment that lacks inviolable controls to enforce this behavior. The disclosed solution implements a soft enforcement strategy that works on every operating system with minimal design impact or overhead.

The system and method disclosed herein allows for completely cross-platform policy enforcement of behaviors well vetted a priori against a policy at run time to enforce “do no harm” principles in software systems. The system and method disclosed herein can exploit this notion to significantly improve the safety and reliability of systems for which no policy enforcement classically could ever have been implemented (such as in most embedded systems). In addition, the system and method disclosed herein uses a custom loader to dynamically load code in an environment that disallows it to perform unvetted behaviors.

When trying to neutralize all agents of a targeted activity, the trust-enhancing agent sandbox plans over a potentially enormous set of facts to determine the next action to take. The trust-enhancing agent sandbox is designed to do no collateral damage while neutralizing the targeted activity, which may be done either by attacking individual nodes or disrupting command and control.

It is important to understand that the trust-enhancing agent sandbox is designed to “trust but verify” machine-generated software over which the program already has a significant amount of control and oversight. The disclosed trust-enhancing agent sandbox juggles a variety of nuanced requirements, constraints, and assumptions in building and executing plans to remediate a targeted activity. The trust-enhancing agent sandbox, or simply agent, executes plans that are only partially worthy of trust, so the execution of plan steps requires some oversight as well. These requirements, assumptions, and constraints include but are not limited to the following. First, the agent must be portable to the widest possible set of Instruction Set Architectures (ISAs) and Operating System (OS) Application Binary Interfaces (ABIs) with minimal effort. Second, third-party developers must be able to port an agent to a new ISA and OS ABI in a few days, and the agent must therefore avoid using any proprietary ISA and OS features to maximize its own portability.

Capabilities that the agent invokes are well-tested in an isolated test environment to characterize and confirm their behaviors before first production use. This allows for semi-automatically building policies that constrain exactly what a capability should be able to do safely, vetted by mission planners. The architecture therefore uses a mandatory-access-control style policy enforcement: anything other than that which is allowed specifically is assumed dangerous and therefore rejected.

The system and method disclosed herein execute the plan as established by a planner. The planner is a reasoning system that aggregates all pertinent information associated with a mission, analyzes that information, and presents suggested actions to its agents that will further the goals of the mission. Agents perform these actions by downloading and executing capabilities in the agent sandbox. Capabilities are software implementations of actions that can be as simple as removing a file on the target system to complex activities such as scanning network traffic for indications of a malware infection. Action results and mission status are continuously fed back into the planner for reevaluation throughout mission execution. The implementation of the planner itself is outside the scope of this disclosure.

Mission planners will set the rules of engagement for the agent and its capabilities before a mission starts by writing a policy in a domain-specific policy-definition language; much of this policy is automatically generated based upon observations made after executing in a test environment, and it undergoes final review by mission planners.

The agent uses a technique called progressive elaboration to uncover additional details about a target environment in an iterative way. The planner builds plans that include steps to elicit more information about the environment until the probability of success of taking some desired, potentially unsafe neutralization action reaches a predetermined threshold of prescribed risks that mission planners are willing to accept. In this way the plans may be imprecise and have a low probability of success in neutralizing early on, but they become progressively more accurate with time. Because of these practical uncertainties, the execution of every step in a plan is placed into a sandbox that guarantees that the plan's actions cannot violate any of the mission planner's policy directives independently from the planner itself; truly a “trust-but-verify” implementation. This reduces the probability of unintended consequences, and it gives planners some probabilistic upper bounds of risk.

The agent incorporates a sandbox that uses the policy created by the planner to constrain the capability's execution. If an action violates a policy directive, the planner should, but is not required to, de-emphasize the selection of this action in the future to avoid its incorporation in new plans. Because this may involve very complex adaptive reasoning that complicates the planner, possibly consuming far too many resources, the sandbox remains always available to guard against potentially errant decision making.

The implementation of this sandbox is as simple as possible to make it easy for engineers to integrate new capabilities. Efficiency of execution is a secondary concern because the performance of the sandbox is fast enough whenever external I/O is involved, which is orders of magnitude slower than the policy implementation logic. Should the overhead be deemed too significant, it is practical to cache responses from the parent and automatically apply these cached results to future executions of the call with identical or similar inputs.

To reduce the ongoing maintenance needed to maintain this sandbox, the system makes its implementation nearly identical on each target platform. A small amount of custom logic may be required per platform or ABI that conforms to a standard interface to allow the system to modularly address the unclean abstractions already in certain operating systems. Take, for example, the means to limit the amount of total CPU or memory a process can take which the system may use to control runaway processes. The means to do this differ slightly between operating systems, but almost every operating system has abstracted some means of doing this. To allow the system to limit the amount of total CPU or memory a process can take may require a small amount of custom logic.

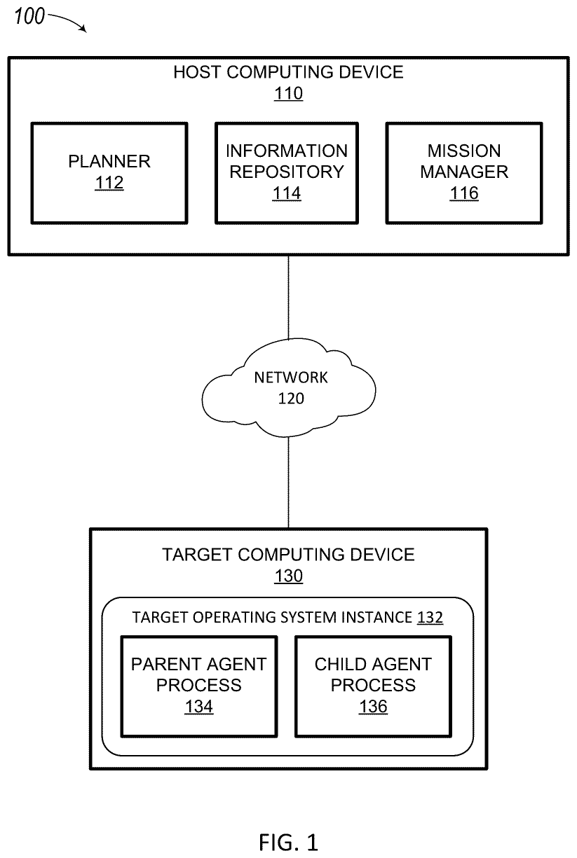

FIG. 1 is a functional block diagram illustrating a distributed data processing environment, generally designated 100, suitable for operation of the sandbox program consistent with the present disclosure. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 100 includes host computing device 110 and target computing device 130 optionally connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between host computing device 110, target computing device 130 and other computing devices (not shown) within distributed data processing environment 100.

Host computing device 110 and target computing device 130 can each be a standalone computing device, a management server, a web server, a mobile computing device, or any other electronic device or computing system capable of receiving, sending, and processing data. In an embodiment, host computing device 110 and target computing device 130 can each be a personal computer (PC), a desktop computer, a laptop computer, a tablet computer, a netbook computer, a smart phone, or any programmable electronic device capable of communicating with other computing devices (not shown) within distributed data processing environment 100 via network 120. In another embodiment, host computing device 110 and target computing device 130 can each represent a server computing system utilizing multiple computers as a server system, such as in a cloud computing environment. In yet another embodiment, host computing device 110 and target computing device 130 each represents a computing system utilizing clustered computers and components (e.g., database server computers, application server computers) that act as a single pool of seamless resources when accessed within distributed data processing environment 100.

In an embodiment, host computing device 110 includes information repository 114. In an embodiment, information repository 114 may be managed by the sandbox program. In an alternate embodiment, information repository 114 may be managed by the operating system of the host computing device 110, alone, or together with, the sandbox program. Information repository 114 is a data repository that can store, gather, compare, and/or combine information. In some embodiments, information repository 114 is located externally to host computing device 110 and accessed through a communication network, such as network 120. In some embodiments, information repository 114 is stored on host computing device 110. In some embodiments, information repository 114 may reside on another computing device (not shown), provided that information repository 114 is accessible by computing device 110. Information repository 114 includes, but is not limited to, planner data, agent data, mission data, network data, sandbox data, system data, and other data that is received by the sandbox program from one or more sources, and data that is created by the sandbox program.

Information repository 114 may be implemented using any non-transitory volatile or non-volatile storage media for storing information, as known in the art. For example, information repository 114 may be implemented with random-access memory (RAM), solid-state drives (SSD), one or more independent hard disk drives, multiple hard disk drives in a redundant array of independent disks (RAID), optical library, or a tape library. Similarly, information repository 114 may be implemented with any suitable storage architecture known in the art, such as a relational database, an object-oriented database, or one or more tables.

In an embodiment, host computing device 110 includes mission manager 116. The mission manager 116 is a version of the agent that aggregates information from the planner, database, e.g., information repository 114, and external sources, and communicates with agents on the target devices, e.g., target computing device 130.

In an embodiment, target computing device 130 includes target operating system instance 132, which includes parent agent process 134 and child agent process 136, which are processes that executes on the target.

In an embodiment, target computing device 130 includes the sandbox program. In an embodiment, the sandbox program is a program, application, or subprogram of a larger program for enforcing policy without collateral damage using an agent sandbox. In an alternative embodiment, the sandbox program may be located on any other device accessible by target computing device 130 via network 120.

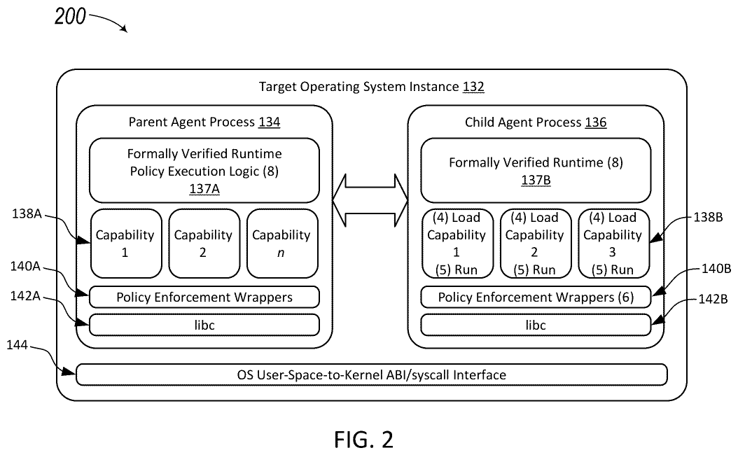

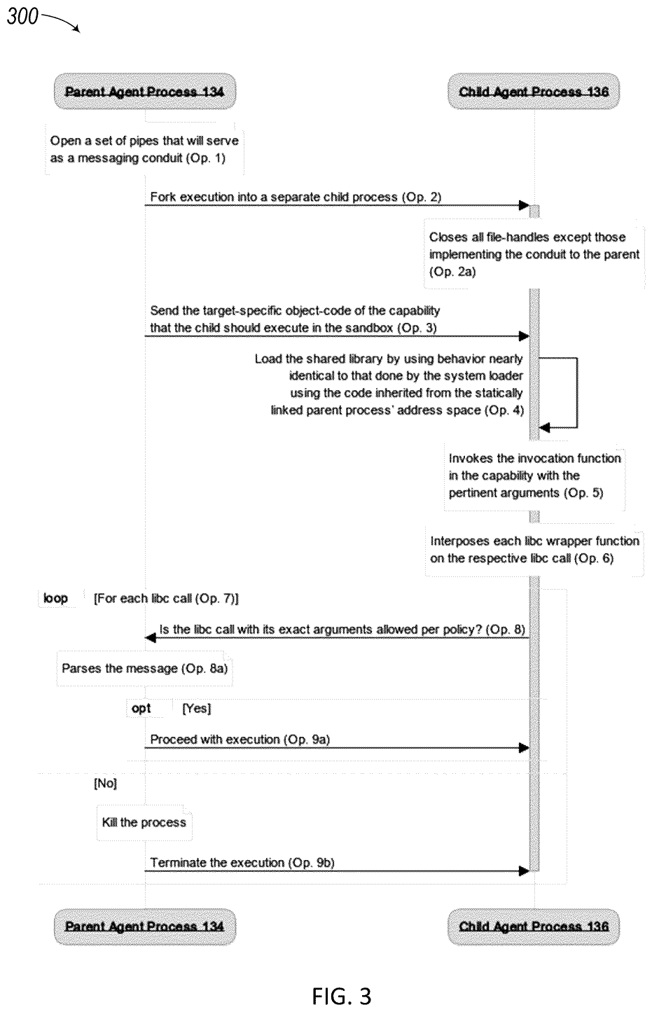

FIG. 2 is an example block diagram illustrating one possible design of the agent sandbox architecture consistent with the present disclosure. In the example block diagram of FIG. 2, the agent sandbox is resident in target operating system instance 132. The agent sandbox includes a parent agent process 134 and a child agent process 136, which is a child agent process created using standard OS process duplication mechanisms. Child agent process 136 contains formally verified runtime 137B, which is the executable on the child. Parent agent process 134 contains formally verified runtime policy execution logic 137A, which adjudicates the calls from child agent process 136 before the child agent process can execute the call in formally verified runtime 137B. The parent agent process 134 contains capabilities 138A, the policy enforcement wrappers 140A, which are interposed on the libc 142A. These are duplicated on the child agent process 136 as capabilities 138B, policy enforcement wrappers 140B and libc 142B. Finally, target operating system instance 132 contain the OS user-space-to-kernel ABI/syscall interface 144. The operational flow of the agent sandbox is further explained in FIG. 3 below.

FIG. 3 is a sequence diagram depicting operations for the sandbox program, for enforcing policy without collateral damage using an agent sandbox, on the distributed data processing environment of FIG. 1, consistent with the present disclosure. In an alternative embodiment, the operations of the sandbox program may be performed by any other program while working with the sandbox program.

It should be appreciated that embodiments of the present disclosure provide at least for enforcing policy without collateral damage using an agent sandbox. However, FIG. 3 provides only an illustration of one implementation and does not imply any limitations with regard to the environments in which different embodiments may be implemented. Many modifications to the depicted environment may be made by those skilled in the art without departing from the scope of the disclosure as recited by the claims.

The sandbox program opens a set of one or more pipes that will serve as a messaging conduit (operation 1). In the illustrated example embodiment, the parent agent process of the sandbox program opens a set of one or more pipes that will serve as a messaging conduit between itself and a child agent process it will fork execution with. The child agent process is typically created using standard OS calls to duplicate the parent agent process.

The sandbox program forks execution into a separate child agent process (operation 2). The sandbox program forks its execution from the parent agent process into a separate child agent process. The OS duplicates the parent agent process' entire address space into the child using a copy-on-write mechanism, ensures all open file-handles are presented into the child agent process, and then vectors execution to the proper instruction just after the fork.

The child agent process closes all file-handles except those implementing the conduit to the parent agent process, and it then blocks execution of the child agent process and waits for a message from the parent agent process (operation 2a).

The sandbox program sends the target-specific object code of the capability that the child should execute in the sandbox (operation 3). The parent agent process of the sandbox program sends the child a message through the conduit that contains the target-specific object-code of the capability that the child should execute in the sandbox with the arguments to the capability invocation function call it should make within that capability.

The parent agent process evaluates the state of the child agent process as well as reads and responds to any messages emitted from the child through the conduit. The parent can detect termination whether graceful or not. It continues executing these behaviors until the child agent process either dies, fails to respond within a timeframe and needs to be killed, is killed because of a policy violation, or exits gracefully.

The messages exchanged between parent and child use a very primitive but easily verifiable type-length-value based mechanism, where the types reference specific serialized flatbuffers messages prescribed for certain classes of capabilities. The capability must use flatbuffers to interact with the agent.

The child agent process receives and parses the message that contains the object-code in dynamic shared-library form and the arguments to the capability invocation function. The shared library may link only to the libc library dynamically and can use any valid libc call. All other logic must be linked statically into that dynamic shared library to include the flatbuffers parsing logic. It should be noted that although this example utilizes libc, any statically linkable C standard library could be used, as would be known by a person skilled in the art.

The sandbox program loads the shared library by using behavior nearly identical to that done by the system loader using the code inherited from the statically linked parent agent process' address space (operation 4). The child agent process of the sandbox program proceeds to load the shared library by using behavior that mimics that done by the system loader, but it does this using the code inherited from the statically linked address space of the parent agent process. It obtains pages of memory from the kernel, sets the permissions bits on those pages, and then proceeds to perform the appropriate fixups on the position-independent logic just loaded.

The fixups done in the child are done specially as compared to the system loader. The custom loader walks through the global offset table and procedure linkage table and ensures that each global symbol and each global executable actually references the address of the global symbol or global executable already found in the statically linked address space of the parent agent process. The basic principle is the same, but the disclosed loader must know the offset of every symbol within the code or data segment of the loaded binary; it cannot look anything up dynamically since it is not linked against ld.so or its kin.

The disclosed loader fixes up libc procedures differently than the standard loader does. For the subset of calls such as strstr that lack system calls, it simply sets the unresolved symbol in the procedure linkage table to refer to the original code already found in the child agent process address space as inherited from the parent agent process via the fork. Any libc calls that do invoke system calls are handled specially; the child agent process instead writes the address of a wrapper function of the disclosed design that matches the function signature of the libc call exactly; where a specific wrapper function exists for each libc call that calls one or more system calls.

The sandbox program invokes the invocation function in the capability with the pertinent arguments (operation 5). Capabilities are generally developed to perform some action on a target. Typical arguments would be the identity of the target, such as a filename for deletion or an IP address to throw an exploit toward, and any other details required to perform the action.

The sandbox program interposes each libc wrapper function on the respective libc call (operation 6). The sandbox program interposes each libc wrapper function on the corresponding libc call to let the policy enforcement engine of the parent agent process confirm that the libc call with its exact arguments is allowed per policy before letting the child agent process actually call the libc code within its address space.

For each libc call (operation 7), each wrapper function running in the capability's child agent process sends a message (using un-hooked libc functions) through the pipe to the parent agent process to have its formally verified runtime adjudicate the capability's call. The capability links statically against flatbuffers logic and dynamically against libc under the assumption that the system loader will resolve all the symbols at load time. The capability therefore is not aware that it is being directed instead to the agent wrapper functions.

The message the wrapper function uses to vet the call indicates the exact libc call along with the exact arguments the capability intends to execute. The policy enforcement logic of the parent agent process interrogates as little or as much of this as needed based upon the nature of the features exposed in policy enforcement.

After sending the message to the parent agent process, the child agent process blocks waiting for an answer back from the enforcement logic in the parent.

The sandbox program determines if the libc call with its exact arguments is allowed per policy (decision block 8). The sandbox program in the parent agent process parses the message (operation 8a) received in operation 7 and determines whether it will allow the child agent process to invoke the requested libc call with one or more given arguments. The parent agent process of the sandbox program determines whether it will allow the child agent process to invoke the requested libc call with the one or more given arguments by comparing the requested call with the one or more given arguments against the policy enforcement logic to determine if the requested libc call with the one or more given arguments is allowed by policy. If the parent agent process of the sandbox program determines that it will allow the child agent process to invoke the requested libc call (“yes” branch, decision block 8), then the sandbox program proceeds to operation 9a. If the parent agent process of the sandbox program determines that it will not allow the child agent process to invoke the requested libc call (“no” branch, decision block 8), then the sandbox program proceeds to operation 9b.

The sandbox program proceeds with execution (operation 9a). If the policy enforcement logic approves the call (“yes” branch, decision block 8), then the parent agent process of the sandbox program simply returns a message to the child agent process indicating that it can proceed, which causes the blocking child agent process to continue executing. The sandbox program then processes the next libc call.

The sandbox program terminates the execution (operation 9b). If the parent agent process of the sandbox program rejects the call (“no” branch, decision block 8), then the parent agent process terminates the child agent process to ensure the unsafe action cannot proceed, and the parent agent process notifies the planner of the termination of the execution of the child agent process to de-emphasize execution of the requested libc call with one or more given arguments from occurring in future plans. The sandbox program then processes the next libc call.

In this way, all other libc calls can be vetted and executed by the child agent process. The capability executes fully and builds its return value flatbuffers and returns them over the pipe.

Note that the parent agent process can optionally constrain the child agent process further with a CGROUPS like capability (Windows JobObjects, for example) to further constrain what the child agent process can consume in terms of CPU, Memory, IO, etc.

The runtime in the parent agent process keeps track of handles returned from system calls to ensure that certain future behaviors can only proceed against specific kernel data structures for which the context makes sense; for example, a write may be allowed only to a socket file handle that was opened to a target with a specific IP address harvested during a prior survey operation, but all other file handle writes will fail by policy. To do this, the policy logic must keep track of these states. In this way, the agent can only execute the specific chains of system calls that have previously been characterized in testing and which are allowed by the developed policies through the official libc wrappers which themselves are guarded through disclosed system's libc wrappers.

Capabilities need only implement a few custom things to support this basic design: they must use a standardized function signature as the entry point to their capability. They must implement the logic to decode and use the arguments to the capability invocation function, which has a standard function signature but that exchanges serialized flatbuffers to case portability. This requires agent developers and the capability developer to agree on some fundamentals about the flatbuffers being exchanged ahead of time. The capability must also implement the encoding method for any return values, and also need to be provided as serialized flatbuffers and done in concurrence with agent developers.

The shared libraries in which capabilities are packaged are nearly unmodified other than to statically link into the code segment any dependencies besides libc which are always resolved dynamically by the agent's loader, and the shared library otherwise looks exactly like any typical GNU Compiler Collection (GCC) built shared library does on the target platform.

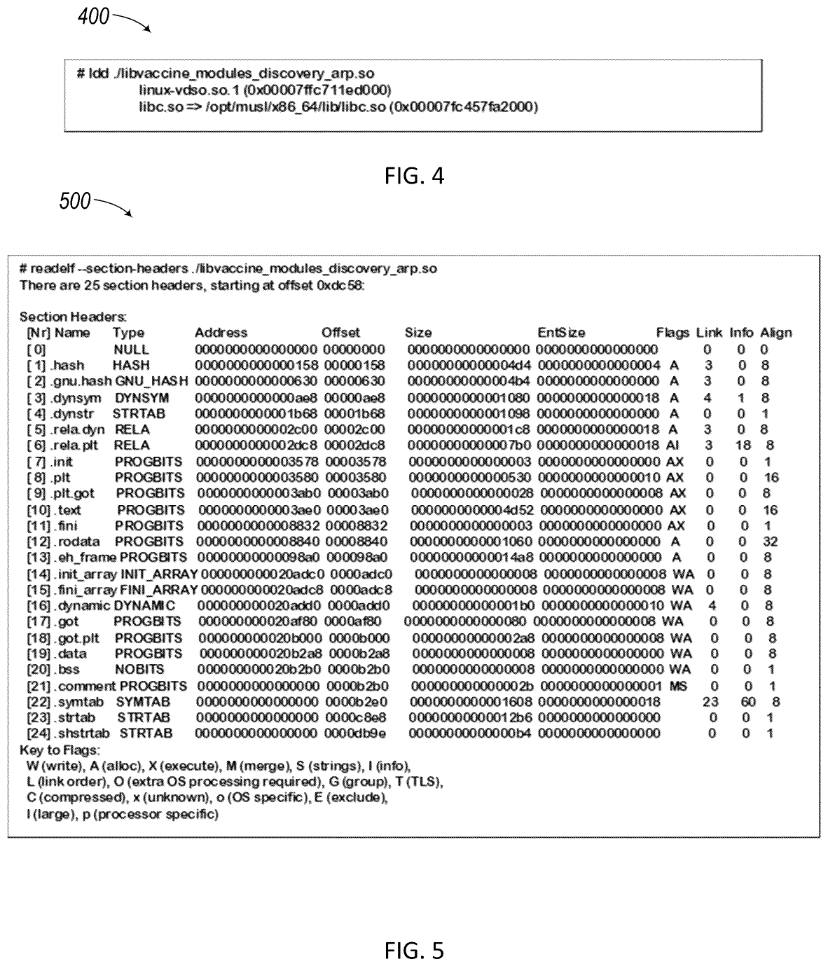

FIGS. 4 through 8C are based on one example capability and are shown for illustrative purposes only.

The capability shown in FIG. 4 is an example of the shared-library linkage for an example capability. It should be noted that it links only against, and is required to link only against libc.so, which the capability loader of the disclosed system addresses in a custom fashion. Linux-vdso is a special shared-library mapped to optimize syscall behaviors in Linux and is ignored by the loader of the disclosed system, which is allowed by specification.

FIG. 5 is an example dump of the sections from the ELF headers of a typical capability shared library consistent with the present disclosure. There are no unusual customizations done during the compiling or link-editing of these shared libraries, making it very easy for developers to integrate this into their exploit build chains.

This section layout in memory is very typical of any normal shared library built to link against libc on any Unix-like platform, Linux and Vx Works being prime examples, but the same basic principles apply when built against Windows Portable Executable format dynamically loadable libraries. Unfortunately, the exact sequence and strategy of layout for a shared library differs on each toolchain and platform because there are no requirements that enforce these section layout details. There is considerably more consistency in the layout of segments into which these sections get allocated, and the ABI does constrain a subset of the details such as calling convention and so forth, but the actual structure of the shared library is not strictly enforced across platforms, so the disclosed system uses whatever the default is on any given platform. As a result, there may be platform-specific layouts of these libraries, and the disclosed system uses whatever the default layout is for the targeted platform. The examples disclosed herein are basic prototypes, and therefore are not precise and representative of every platform and toolchain, as a person skilled in the art should realize.

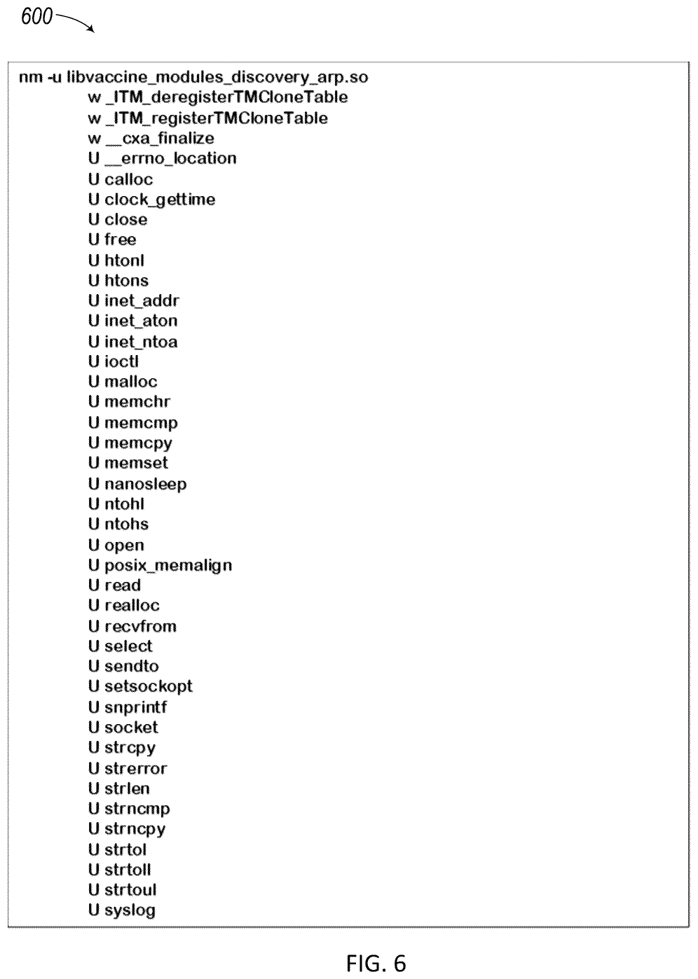

FIG. 6 is an example of the unresolved symbols in a typical capability, consistent with the present disclosure. These symbols will all be resolved by the disclosed loader as described elsewhere in this document. Note that capabilities are free to call any libc call available, and the loader will gracefully redirect all calls to the policy enforcement engine. Further note that capability authors are free to statically link any libc calls that lack direct syscalls, for example, strncpy.

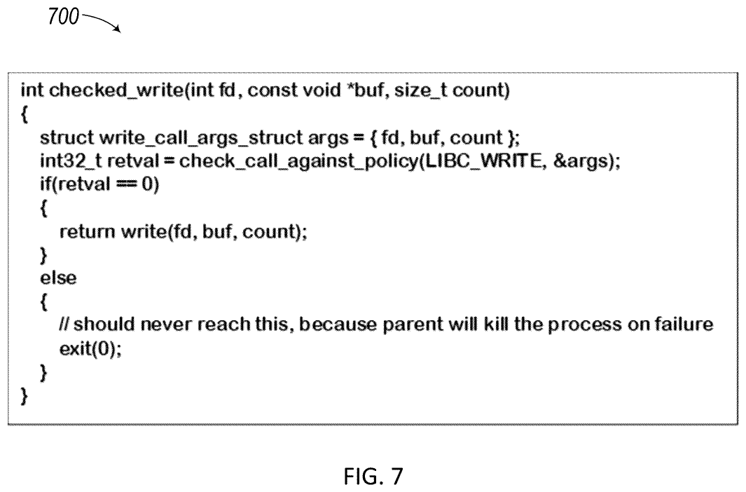

FIG. 7 is an example of an agent wrapper function that checks the invocation of the libc call write( ) consistent with the present disclosure. The loader for this capability will direct all calls that were originally intended for write( ) to this checked_write( ) function of the disclosed system.

Of note in this example is that checked_write( ) calls a helper function already implemented within the example agent shown in FIG. 7 that calls back to the parent agent process through the pipe between processes and sends the parent the request to vet the call with its arguments. The parent agent process will simply kill the child agent process if anything is amiss, so the else block in this example should never execute.

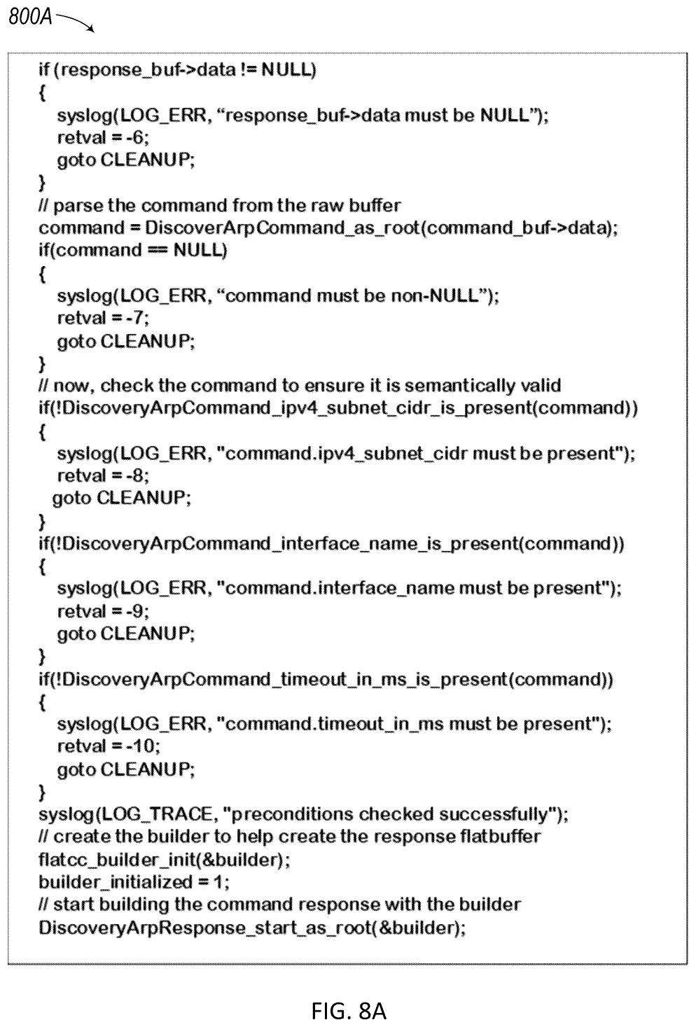

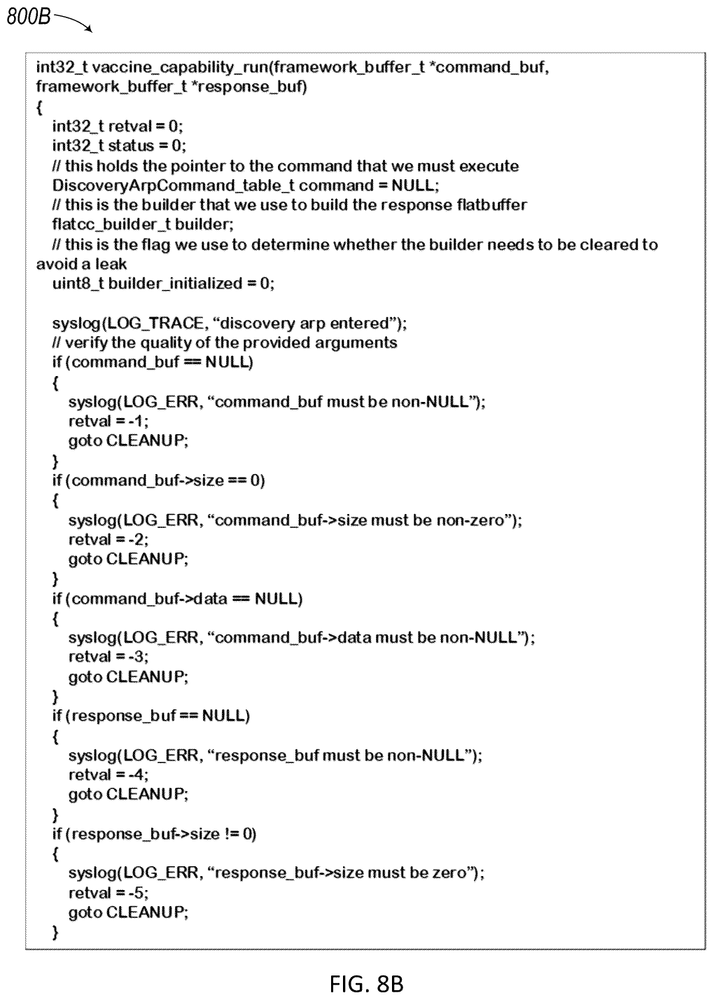

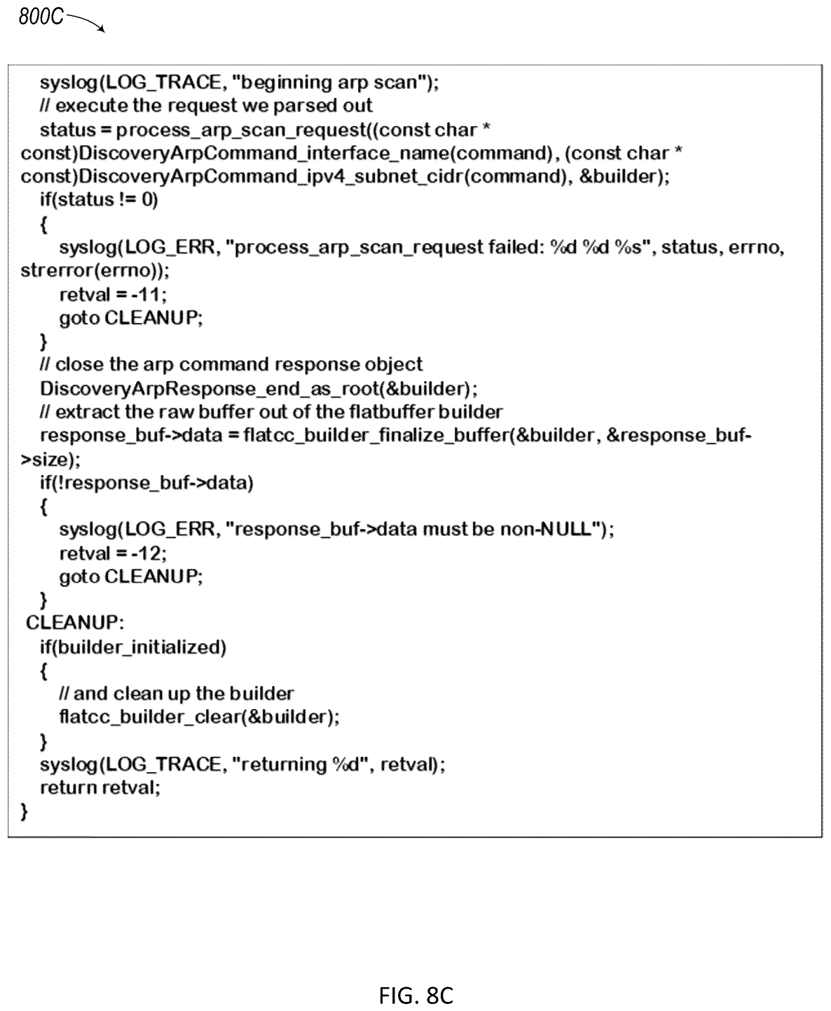

FIGS. 8A, 8B, and 8C are one example of the entry-point function that every capability must implement to allow the example agent to invoke the capability consistent with the present disclosure. Note that framework_buffer_t in this example is simply a structure with a void pointer to data with a size in size_t.

The following should be noted from this example. First, the agent will provide a serialized flatbuffer to the capability to encode the arguments that the capability must be used for invocation; the schema of this flatbuffer must be known a priori and the planner reasons over the contents of this structure. Second, the agent expects to be provided a serialized flatbuffer back from the capability that encodes any return values from the capability; the schema of this flatbuffer must be known a priori and the planner reasons over the contents of this structure.

A high-level example is provided to illustrate the basic mechanics of this design. In this example, the planner concludes that the agent must ARP scan the subnet 192.168.0.0/24 through interface eth0. The capability will call a libc call that results in a system call that obtains the details of the eth0 interface configuration. The disclosed system interposes a wrapper on this libc call which causes its intent with arguments to be sent to the parent agent process for verification. If the parent agent process determines that the capability is attempting to assess the state of an interface that it should not be touching, perhaps because of an off-by-one error in some other part of the logic and requested details on eth1 instead, it terminates the capability. The parent agent process may also allow the capability to call the various libc syscall wrappers that open raw sockets to allow the client to generate the ARP datagrams and receive their replies, but other libc calls to open files and so forth will be denied by policy.

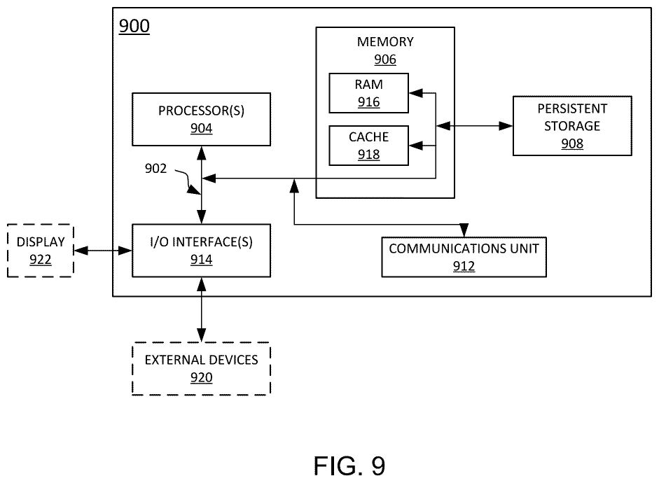

FIG. 9 is a block diagram depicting components of one example of a computing device, e.g., host computing device 110 or target computing device 130, suitable for the sandbox program, within the distributed data processing environment of FIG. 1, consistent with the present disclosure. FIG. 9 displays the computing device or computer 900, one or more processor(s) 904 (including one or more computer processors), a communications fabric 902, a memory 906 including, a random-access memory (RAM) 916 and a cache 918, a persistent storage 908, a communications unit 912, I/O interfaces 914, a display 922, and external devices 920. It should be appreciated that FIG. 9 provides only an illustration of one embodiment and does not imply any limitations with regard to the environments in which different embodiments may be implemented. Many modifications to the depicted environment may be made.

As depicted, the computer 900 operates over the communications fabric 902, which provides communications between the computer processor(s) 904, memory 906, persistent storage 908, communications unit 912, and input/output (I/O) interface(s) 914. The communications fabric 902 may be implemented with an architecture suitable for passing data or control information between the processors 904 (e.g., microprocessors, communications processors, and network processors), the memory 906, the external devices 920, and any other hardware components within a system. For example, the communications fabric 902 may be implemented with one or more buses.

The memory 906 and persistent storage 908 are non-transitory computer readable storage media. In the depicted embodiment, the memory 906 comprises a RAM 916 and a cache 918. In general, the memory 906 can include any suitable volatile or non-volatile computer readable storage media. Cache 918 is a fast memory that enhances the performance of processor(s) 904 by holding recently accessed data, and near recently accessed data, from RAM 916.

Program instructions for the sandbox program may be stored in the persistent storage 908, or more generally, any non-transitory computer readable storage media, for execution by one or more of the respective computer processors 904 via one or more memories of the memory 906. The persistent storage 908 may be a magnetic hard disk drive, a solid-state disk drive, a semiconductor storage device, flash memory, read only memory (ROM), electronically erasable programmable read-only memory (EEPROM), or any other non-transitory computer readable storage media that is capable of storing program instruction or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer readable storage medium that is also part of persistent storage 908.

The communications unit 912, in these examples, provides for communications with other data processing systems or devices. In these examples, the communications unit 912 includes one or more network interface cards. The communications unit 912 may provide communications through the use of either or both physical and wireless communications links. In the context of some embodiments of the present disclosure, the source of the various input data may be physically remote to the computer 900 such that the input data may be received, and the output similarly transmitted via the communications unit 912.

The I/O interface(s) 914 allows for input and output of data with other devices that may be connected to computer 900. For example, the I/O interface(s) 914 may provide a connection to external device(s) 920 such as a keyboard, a keypad, a touch screen, a microphone, a digital camera, and/or some other suitable input device. External device(s) 920 can also include portable computer readable storage media such as, for example, thumb drives, portable optical or magnetic disks, and memory cards. Software and data used to practice embodiments of the present disclosure, e.g., the sandbox program, can be stored on such portable computer readable storage media and can be loaded onto persistent storage 908 via the I/O interface(s) 914. I/O interface(s) 914 also connect to a display 922.

Display 922 provides a mechanism to display data to a user and may be, for example, a computer monitor. Display 922 can also function as a touchscreen, such as a display of a tablet computer.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-exhaustive list of more specific examples of the one or more non-transitory computer readable storage media includes the following: a portable computer diskette, a hard disk, a RAM, a ROM, an EPROM or Flash memory, a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

Computer readable program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in one or more non-transitory computer readable storage media that can direct a computer, a programmable data processing apparatus, and/or other devices to function in a particular manner, such that the one or more non-transitory computer readable storage media having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

According to one aspect of the disclosure there is thus provided a system for enforcing policy without collateral damage using an agent sandbox, the system including: one or more computer processors; one or more non-transitory computer readable storage media; and program instructions stored on the one or more non-transitory computer readable storage media for execution by at least one of the one or more computer processors. The program instructions include instructions to fork execution from a parent agent process into a child agent process; receive on the child agent process a target-specific object code of a capability from the parent agent process; load on the child agent process a shared library using code inherited from a statically linked address space of the parent agent process; interpose each standard C library (libc) wrapper function on the child agent process on a corresponding libc call. For each libc call, parse a message on the parent agent process to determine if the libc call with one or more exact arguments is allowed by policy; responsive to determining that the libc call with the one or more exact arguments is allowed by policy, proceed with the execution; and responsive to determining that the libc call with the one or more exact arguments is not allowed by policy, terminate the child agent process.

According to another aspect of the disclosure there is thus provided a computer-implemented method for enforcing policy without collateral damage using an agent sandbox, the computer-implemented method including forking, by one or more computer processors, execution from a parent agent process into a child agent process; receiving, by the one or more computer processors, on the child agent process a target-specific object code of a capability from the parent agent process; loading, by the one or more computer processors, on the child agent process a shared library using code inherited from a statically linked address space of the parent agent process; interposing by the one or more computer processors, each standard C library (libc) wrapper function on the child agent process on a corresponding libc call. For each libc call, parsing, by the one or more computer processors, a message on the parent agent process to determine if the libc call with one or more exact arguments is allowed by policy; responsive to determining that the libc call with the one or more exact arguments is allowed by policy, proceeding, by the one or more computer processors, with the execution; and responsive to determining that the libc call with the one or more exact arguments is not allowed by policy, terminating, by the one or more computer processors, the child agent process.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for enforcing policy without collateral damage using an agent sandbox, the system comprising:
one or more computer processors;
one or more non-transitory computer readable storage media; and
program instructions stored on the one or more non-transitory computer readable storage media for execution by at least one of the one or more computer processors, the program instructions including instructions to:
fork execution from a parent agent process into a child agent process;
receive on the child agent process a target-specific object code of a capability from the parent agent process;
load on the child agent process a shared library using code inherited from a statically linked address space of the parent agent process;
interpose each standard C library (libc) wrapper function on the child agent process on a corresponding libc call; and
for each libc call:
parse a message on the parent agent process to determine if the libc call with one or more exact arguments is allowed by policy;
responsive to determining that the libc call with the one or more exact arguments is allowed by policy, proceed with the execution; and
responsive to determining that the libc call with the one or more exact arguments is not allowed by policy, terminate the child agent process.

2. The system of claim 1, wherein the parent agent process opens a set of one or more pipes to serve as a messaging conduit between the parent agent process and the child agent process.

3. The system of claim 2, wherein fork execution from the parent agent process into the child agent process further comprises one or more of the following program instructions, stored on the one or more non-transitory computer readable storage media, to:
close all file-handles on the child agent process except those implementing a conduit to the parent agent process.

4. The system of claim 3, wherein fork execution from the parent agent process into the child agent process further comprises one or more of the following program instructions, stored on the one or more non-transitory computer readable storage media, to:
block execution on the child agent process until the message from the parent agent process is received.

5. The system of claim 2, wherein load on the child agent process the shared library using code inherited from the statically linked address space of the parent agent process further comprises one or more of the following program instructions, stored on the one or more non-transitory computer readable storage media, to:
load the shared library on the child agent process using a behavior to that mimics a system loader, wherein the child agent process uses the code inherited from the statically linked address space of the parent agent process;
set one or more permissions bits on one or more pages of memory obtained from an operating system (OS) kernel; and
perform one or more appropriate fixups on the shared library.

6. The system of claim 5, wherein the one or more appropriate fixups are applied to a global offset table and a procedure linkage table to ensure that each global symbol and each global executable reference a first address of the global symbol already found in the statically linked address space of the parent agent process.

7. The system of claim 6, wherein the appropriate fixups for a libc call that invokes a system call further comprises one or more of the following program instructions, stored on the one or more non-transitory computer readable storage media, to:
write a second address of a wrapper function that matches a function signature of the libc call exactly, wherein a specific wrapper function exists for each libc call that calls one or more system calls.

8. The system of claim 7, wherein parse the message on the parent agent process to determine if the libc call with the one or more exact arguments is allowed by the policy comprises one or more of the following program instructions, stored on the one or more non-transitory computer readable storage media, to:
send the message from the child agent process to the parent agent process using any pipe of the set of the one or more pipes, wherein the message indicates an exact libc call along with the exact arguments the capability intends to execute; and
parse the message on the parent agent process to determine if the libc call with the one or more exact arguments is allowed by policy.

9. The system of claim 1, wherein fork execution from the parent agent process into the child agent process further comprises one or more of the following program instructions, stored on the one or more non-transitory computer readable storage media, to:
duplicate an entire address space of the parent agent process into the child agent process; and
vector execution on the child agent process to a proper instruction just after the fork execution.

10. The system of claim 1, wherein responsive to determining that the libc call with the one or more exact arguments is not allowed by policy, terminate the child agent process further comprises one or more of the following program instructions, stored on the one or more non-transitory computer readable storage media, to:
notify a planner of termination of the execution of the child agent process to de-emphasize execution of a requested libc call with one or more given arguments from occurring in future plans.

11. A computer-implemented method for enforcing policy without collateral damage using an agent sandbox, the computer-implemented method comprising:
forking, by one or more computer processors, execution from a parent agent process into a child agent process;
receiving, by the one or more computer processors, on the child agent process a target-specific object code of a capability from the parent agent process;
loading, by the one or more computer processors, on the child agent process a shared library using code inherited from a statically linked address space of the parent agent process;
interposing by the one or more computer processors, each standard C library (libc) wrapper function on the child agent process on a corresponding libc call; and
for each libc call:
parsing, by the one or more computer processors, a message on the parent agent process to determine if the libc call with one or more exact arguments is allowed by policy;
responsive to determining that the libc call with the one or more exact arguments is allowed by policy, proceeding, by the one or more computer processors, with the execution; and
responsive to determining that the libc call with the one or more exact arguments is not allowed by policy, terminating, by the one or more computer processors, the child agent process.

12. The computer-implemented method of claim 11, wherein the parent agent process opens a set of one or more pipes to serve as a messaging conduit between the parent agent process and the child agent process.

13. The computer-implemented method of claim 12, wherein forking execution from the parent agent process into the child agent process further comprises:
closing, by the one or more computer processors, all file-handles on the child agent process except those implementing a conduit to the parent agent process.

14. The computer-implemented method of claim 11, wherein forking execution from the parent agent process into the child agent process further comprises:
blocking, by the one or more computer processors, execution on the child agent process until the message from the parent agent process is received.

15. The computer-implemented method of claim 12, wherein loading on the child agent process the shared library using code inherited from the statically linked address space of the parent agent process further:
loading, by the one or more computer processors, the shared library on the child agent process using a behavior to that mimics a system loader, wherein the child agent process uses the code inherited from the statically linked address space of the parent agent process;
setting, by the one or more computer processors, one or more permissions bits on one or more pages of memory obtained from an operating system (OS) kernel; and
performing, by the one or more computer processors, one or more appropriate fixups on the shared library.

16. The computer-implemented method of claim 15, wherein the one or more appropriate fixups are applied to a global offset table and a procedure linkage table to ensure that each global symbol and each global executable reference a first address of the global symbol already found in the statically linked address space of the parent agent process.

17. The computer-implemented method of claim 15, wherein the appropriate fixups for a libc call that invokes a system call further comprises:
writing, by the one or more computer processors, a second address of a wrapper function that matches a function signature of the libc call exactly, wherein a specific wrapper function exists for each libc call that calls one or more system calls.

18. The computer-implemented method of claim 17, wherein parsing the message on the parent agent process to determine if the libc call with the one or more exact arguments is allowed by policy comprises:
sending, by the one or more computer processors, the message from the child agent process to the parent agent process using any pipe of the set of the one or more pipes, wherein the message indicates an exact libc call along with the exact arguments the capability intends to execute; and
parsing, by the one or more computer processors, the message on the parent agent process to determine if the libc call with the one or more exact arguments is allowed by policy.

19. The computer-implemented method of claim 11, wherein forking execution from the parent agent process into the child agent process further comprises:
duplicating, by the one or more computer processors, an entire address space of the parent agent process into the child agent process; and
vectoring, by the one or more computer processors, execution on the child agent process to a proper instruction just after the fork execution.

20. The computer-implemented method of claim 11, wherein responsive to determining that the libc call with the one or more exact arguments is not allowed by policy, terminating the child agent process further comprises:
notifying, by the one or more computer processors, a planner of termination of the execution of the child agent process to de-emphasize execution of a requested libc call with one or more given arguments from occurring in future plans.
